(19) United States
(12) Patent Application Publication
(10) Pub. No.: US 2013/0309904 A1
(43) Pub. Date: Nov. 21, 2013

(54) COAXIAL CONNECTOR ASSEMBLY

(71) Applicants: John Wesley Hall, Harrisburg, PA (US); Douglas John Hardy, Middletown, PA (US); Raymond John DeMarchis, JR., Enola, PA (US)

(72) Inventors: John Wesley Hall, Harrisburg, PA (US); Douglas John Hardy, Middletown, PA (US); Raymond John DeMarchis, JR., Enola, PA (US)

(73) Assignee: Tyco Electronics Corporation, Berwyn, PA (US)

(21) Appl. No.: 13/473,371

(22) Filed: May 16, 2012

(51) Int. Cl. H01R 9/05

(52) U.S. Cl. 439/578

(57) ABSTRACT

A coaxial connector assembly includes a housing having a mating end and a mounting end having anvils. The housing has a cavity. A center contact is received in the cavity that includes a mating end and a terminating end. An outer contact is received in the cavity. The outer contact has a mating cylinder surrounding the center contact. The outer contact has mounting legs extending from the mating cylinder that extend through the housing to the mounting end of the housing. The mounting legs are formed against the anvils for termination to a circuit board.

### BACKGROUND OF THE INVENTION

The subject matter herein relates generally to coaxial connector assemblies.

Radio frequency (RF) connector assemblies have been used for numerous applications, including automotive applications, such as global positioning systems (GPS), car radios, mobile phones, air bag systems, and multimedia devices. The connector assemblies are typically coaxial cable connectors that are provided at the end of coaxial cables. However, at least some known RF connector assemblies are directly mounted to circuit boards.

In order to standardize various types of connector assemblies, particularly the interfaces for such connector assemblies, certain industry standards have been established. One of these standards is referred to as FAKRA. FAKRA is the Automotive Standards Committee in the German Institute for Standardization, representing international standardization interests in the automotive field. The FAKRA standard provides a system, based on keying and color coding, for proper connector attachment. Like keys can only be connected to like keyways in FAKRA connectors. Secure positioning and locking of connector housings is facilitated by way of a FAKRA defined catch on one housing and a cooperating latch on the other housing.

Male connectors, such as those used within the FAKRA standard, typically include a shell and an outer contact surrounding a center contact with a dielectric therebetween. The center contact may define a pin at the mating end for mating with the corresponding female connector. In conventional male connectors, the various components thereof, such as the shell, the outer contact, the dielectric and/or the center contact, are machine screwed. However, such processes may be time consuming and/or expensive.

A need remains for a coaxial connector assembly that may be manufactured efficiently and inexpensively.

### BRIEF DESCRIPTION OF THE INVENTION

In one embodiment, a coaxial connector assembly is provided that includes a housing having a mating end and a mounting end having anvils. The housing has a cavity. A center contact is received in the cavity that includes a mating end and a terminating end. An outer contact is received in the cavity. The outer contact has a mating cylinder surrounding the center contact. The outer contact has mounting legs extending from the mating cylinder that extend through the housing to the mounting end of the housing. The mounting legs are formed against the anvils for termination to a circuit board.

In another embodiment, a coaxial connector assembly is provided including a FAKRA compliant housing having a mating end and a mounting end. The mating end provides an SMB interface keyed according to desired FAKRA specifications. The housing has a base at the mounting end and a shell at the mating end defining a cavity configured to receive a mating connector assembly. The housing has an outer contact support extending from the base into the cavity. The base, shell and outer contact support are formed integral with one another. A center contact is received in the cavity inside the outer contact support that includes a mating end and a terminating end. An outer contact is received in the cavity and includes a mating cylinder and mounting legs extending from the mating cylinder. The mounting legs extend from the mounting end of the housing for termination to a circuit board. The mating cylinder peripherally surrounds the outer contact support.

In a further embodiment, a coaxial connector assembly is provided including a FAKRA compliant housing having a mating end and a mounting end. The mating end provides an SMB interface keyed according to desired FAKRA specifications. The housing has a cavity at the mating end configured to receive a mating connector assembly. The housing has an outer contact support extending into the cavity. A center contact is received in the cavity inside the outer contact support having a mating end and a terminating end. An outer contact is received in the cavity. The outer contact includes a stamped and formed body defining a mating cylinder and mounting legs extending from the mating cylinder. The mounting legs extend from the mounting end of the housing for termination to a circuit board. The mating cylinder peripherally surrounds the outer contact support.

### BRIEF DESCRIPTION OF THE DRAWINGS

FIG. 1 is a front perspective view of a coaxial connector assembly formed in accordance with an exemplary embodiment.

FIG. 2 is an exploded perspective view of the coaxial connector assembly.

FIG. 3 is a partial sectional view of the coaxial connector assembly in an assembled state.

FIG. 4 is a rear perspective view of the coaxial connector assembly.

FIG. 5 is a rear perspective, partial sectional view of the coaxial connector assembly.

FIG. 6 is a rear perspective, partial sectional view of the coaxial connector assembly.

FIG. 7 is a rear perspective view of the coaxial connector assembly.

### DETAILED DESCRIPTION OF THE INVENTION

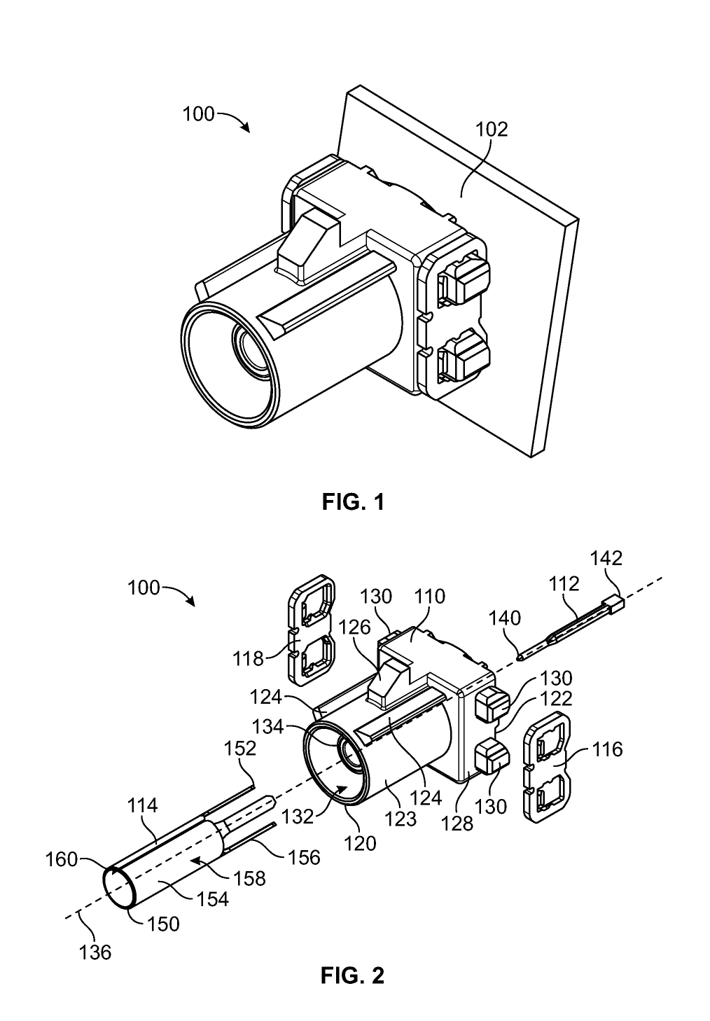

FIG. 1 is a front perspective view of a coaxial connector assembly 100 formed in accordance with an exemplary embodiment. The coaxial connector assembly 100 is mounted to a circuit board 102, which may form part of a communication system, such as for an automotive vehicle. For example, the system may be used in an automotive application, such as a global positioning system (GPS), car radio, mobile phone, air bag system, multimedia device system, and the like. The system may have use in other types of applications such as aeronautic applications, marine applications, military applications, industrial applications and the like. The circuit board 102 may form part of an antenna. The circuit board 102 may form part of a radio frequency (RF) system.

In the illustrated embodiment, the coaxial connector assembly 100 constitutes a male assembly that is configured to be mated with a corresponding female assembly as the corresponding mating connector assembly (not shown). In an exemplary embodiment, the coaxial connector assembly 100 is a standardize connector, such as a FAKRA standardized connector. The coaxial connector assembly 100 has features designed according to desired FAKRA specifications. For example, the coaxial connector assembly 100 may have certain keying configurations.

FIG. 2 is an exploded perspective view of the coaxial connector assembly 100. The coaxial connector assembly 100 includes a housing 110, a center contact 112, an outer contact 114 and solder clips 116, 118. The center contact 112 and outer contact 114 are received in the housing 110. The soldered clips 116, 118 are coupled to the housing 110 for securing the housing 110 to the circuit board 102 (shown in FIG. 1).

The housing 110 has a mating end 120 and a mounting end 122. The mating end 120 is configured for mating with the corresponding mating connector (not shown). The housing 110 includes a shell 123 at the mating end 120. Optionally, the shell 123 may be cylindrical in shape. The mating end 120 provides an interface keyed according to FAKRA specifications. For example, the mating end 120 includes keys 124 on an exterior surface of the housing 110. The size, shape and/orientation of the keys 124 may be used to define the different FAKRA interfaces. The mating end 120 defines a FAKRA compliant housing 110. In an alternative embodiment, the housing 110 may be designed to different standards or to mate with a different type of a mating connector.

The housing 110 includes a catch 126 at the mating end 120. The catch 126 is used for securing the coaxial connector assembly 100 to the mating connector assembly, which may include a latch assembly that engages the catch 126.

The housing 110 includes a base 128 at the mounting end 122. In the illustrated embodiment, the base 128 is generally boxed shaped, however the base 128 may have other shapes in alternative embodiments. The base 128 includes mounting lugs 130 extending from the base 128. The soldered clips 116, 118 are coupled to the mounting lugs 130. Other types of features may be provided in alternative embodiments to secure the solder clips 116, 118 to the housing 110.

The housing 110 includes a cavity 132. The shell 123 defines at least a portion of the cavity 132. The center contact 112 and the outer contact 114 are loaded into the cavity 132. A portion of the mating connector is configured to be received in the cavity 132. In an exemplary embodiment, the housing 110 includes an outer contact support 134 within the cavity 132. The outer contact support 134 is used to support the outer contact 114 when the outer contact 114 is loaded into the housing 110.

The coaxial connector assembly 100 extends along the longitudinal axis 136. The coaxial connector assembly 100 is mated to the mating connector assembly in a mating direction along the longitudinal axis 136. The cavity 132 of the housing 110 generally extends along the longitudinal axis 136. The center contact 112 generally extends along the longitudinal axis 136. The outer contact 114 generally extends along the longitudinal axis 136. In an exemplary embodiment, the circuit board 102 is oriented generally perpendicular to the longitudinal axis 136. The coaxial connector assembly 100 extends vertically from the circuit board 102 (when the circuit board 102 is oriented generally horizontally) along the longitudinal axis 136.

The center contact 112 extends between a mating end 140 and a terminating end 142. In the illustrated embodiment, the mating end 140 constitutes a pin, however other types of mating interfaces may be provided in alternative embodiments. For example, the mating end may be a socket, a blade, deflectable spring beams, or another type of mating interface. The terminating end 142 is configured to be terminated to the circuit board 102. Optionally, the terminated end 142 may be surface mounted to the circuit board 102, such as by using a solder ball, a deflectable spring or another type of interface. In an alternative embodiment, the terminating end 142 may include a straight pin or a compliant pin, such as an eye-of-the-needle pin, for through-hole mounting to a corresponding via of the circuit board 102.

The outer contact 114 has a mating end 150 and a mounting end 152. The mating end 150 is configured to be mated to the mating connector assembly. The mounting end 152 is configured to be mechanically and electrically connected to the circuit board 102. The outer contact 114 has a mating cylinder 154 at the mating end 150. The outer contact 114 has mounting legs 156 at the mounting end 152. In an exemplary embodiment, the mounting legs 156 extend rearward from the mating cylinder 154. The mounting legs 156 are configured to extend through the housing 110 to the mounting end 122 of the housing 110 for termination to the circuit board 102. Any number of mounting legs 156 may be provided. In the illustrated embodiment, the outer contact 114 includes four mounting legs 156.

In an exemplary embodiment, the outer contact 114 includes a stamped and formed body 158 defining the mating cylinder 154 and the mounting legs 156. The body 158 has a seam 160 extending lengthwise along the mating cylinder 154. During manufacture, after the body 158 is stamped, edges of the body 158 are rolled together to define the seam 160. The mating cylinder 154 has a tubular shape. The mating cylinder 154 is hollow and is configured to receive the center contact 112 therein.

In an exemplary embodiment, during assembly, the center contact 112 is loaded into the housing 110 through the mounting end 122. The mating end 140 of the center contact 112 is positioned within the cavity 132 near the mating end 120 of the housing 110. In an exemplary embodiment, during assembly, the outer contact 114 is loaded into the cavity 132 through the mating end 120 of the housing 110. The mounting legs 156 are loaded through the base 128 and extend reward of the mounted end 122 of the housing 110. The mating cylinder 154 is coupled to the outer contact support 134, which provides support for the mating cylinder 154. The mating end 150 of the outer contact 114 is positioned near the mating end 120 of the housing 110. The outer contact 114 generally surrounds the center contact 112 in a coaxial configuration to provide electrical shielding for the center contact 112. The outer contact 114 is electrically isolated from the center contact 112, such as by the dielectric material of the housing 110 and/or air gaps between the outer contact 114 and the center contact 112.

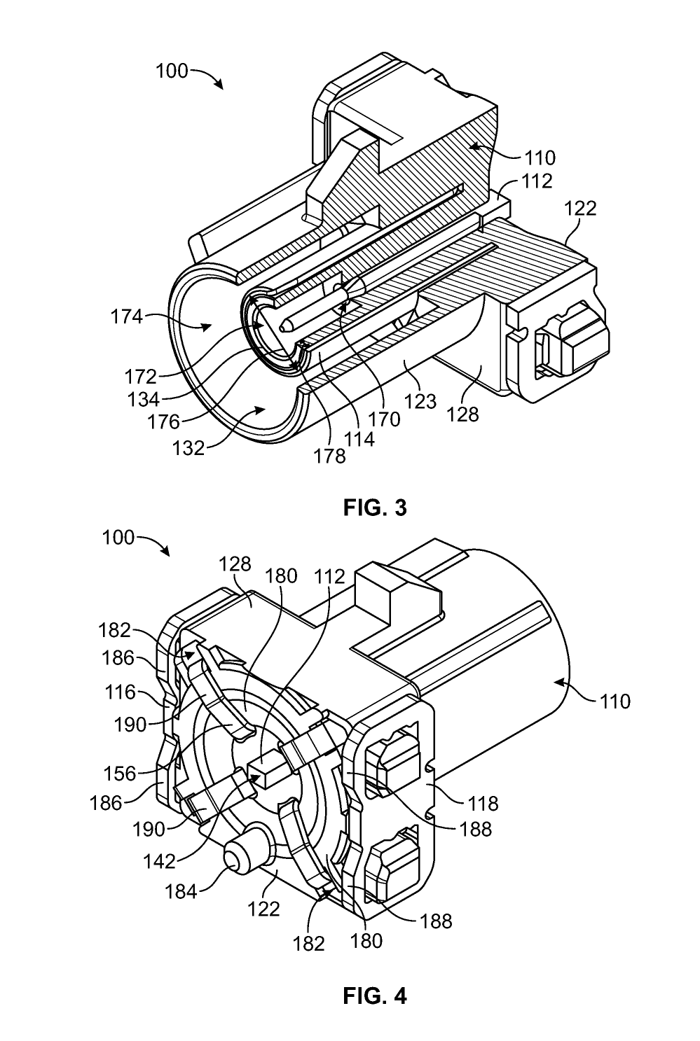

FIG. 3 is a partial sectional view of the coaxial connector assembly 100 in an assembled state. The housing 110 includes a bore 170 extending through the base 128. The center contact 112 is received in the bore 170. The bore 170 extends between the mounting end 122 of the housing 110 and the cavity 132. The center contact 112 is loaded into the bore 170 through the mounting end 122 of the housing 110. A portion of the center contact 112 extends beyond the bore 170 into the cavity 132. In an alternative embodiment, the center contact 112 may be loaded into the bore 170 through the mating end 120 of the housing 110.

The outer contact support 134 extends from the base 128 into the cavity 132. The outer contact support 134 is integrally formed with the base 128 and the shell 123 of the housing 110. For example, the housing 110 may be manufactured by a molding process, such as an injection molding process, using a dielectric material, such as a plastic material. The outer contact support 134, base 128 and shell 123 may be co-molded during a common molding process.

The outer contact support 134 divides the cavity 132 into a socket recess 172 and an outer contact recess 174. The socket recess 172 is inside the outer contact support 134 and the outer contact recess 174 is between the outer contact support 134 and the shell 123. The socket recess 172 is configured to receive a socket (not shown) of the mating connector assembly (not shown). The center contact 112 is exposed within the socket recess 172 for mating with such socket. The outer contact recess 174 is configured to receive a mating outer contact (not shown) of the mating connector assembly. The outer contact 114 is also positioned within the outer contact recess 174. The outer contact 114 is electrically connected to the corresponding mating outer contact of the mating connector assembly when received in the outer contact recess 174.

The outer contact 114 has an outer diameter 176, which may be selected to meet a desired specification, such as to define FAKRA interface, an SMB interface or another desired interface. A thickness 178 of the outer contact support 134 may be controlled to tune the coaxial connector assembly 100, such as to achieve a target impedance between the outer contact 114 and the center contact 112 and/or the mating contact of the mating connector assembly. For example, based on the material selected for the housing 110, and thus the outer contact support 134, the thickness 178, in addition to any air gaps provided between the outer contact support 134 and the center contact 112 and/or the mating contact of the mating connector assembly, may be controlled to achieve a target impedance.

FIG. 4 is a rear perspective view of the coaxial connector assembly 100. The mounting legs 156 of the outer contact 114 (shown in FIG. 2) are bent for surface mounting the outer contact 114 to the circuit board 102 (shown in FIG. 1). In an exemplary embodiment, the mounting legs 156 may be bent in a different manner such that the outer contact 114 may be through-hole mounted rather than surface mounted to the circuit board 102. The same component, namely the outer contact 114, may be used for both surface mounting and through-hole mounting, with only a modification to the forming of the mounting legs 156 after the outer contact 114 is coupled to the housing 110.

The housing 110 includes a plurality of anvils 180 at the mounting end 122. The anvils 180 are positioned at or near the escape points of the mounting legs 156 through the base 128. The anvils 180 are shaped to form, such as by bending, the mounting legs 156 on the anvils 180. The mounting legs 156 may be bent on the anvils 180 in a controlled manner to ensure that the mounting legs 156 are co planar for surface mounting to the circuit board 102.

In the illustrated embodiment, four mounting legs 156 are provided. The mounting legs 156 are bent toward the four corners of the base 128. The housing 110 includes recesses 182 in the base 128 that receive ends of the mounting legs 156. For example, the mounting legs 156 may be bent outward against the anvils 180 and the distal ends of the mounting legs 156 may be bent into the recesses 182. In an exemplary embodiment, a back angle is formed at each recess 182 to tightly hold the mounting legs 156 in the recesses 182 and against the anvils 180 for surface mounting to the circuit board 102. The back angles help to ensure that the distal ends of the mounting legs 156 do not back out of the recesses 182, but rather the distal ends tend to press against the wall defining the recesses 182.

In an exemplary embodiment, the housing 110 includes one or more locating post 184 extending from the base 128. The locating post 184 is configured to be received in a corresponding opening of the circuit board 102 to orient the coaxial connector assembly 100 on the circuit board 102.

The solder clips 116, 118 are coupled to the base 128 to secure the housing 110 to the circuit board 102. The solder clips 116, 118 have edges 186, 188, respectively. The edges 186, 188 are co planar with mounting interfaces 190 of the mounting legs 156 for surface mounting to the circuit board 102. The solder clips 116, 118 are soldered to corresponding mounting pad on the circuit board 102. The mounting legs 156 are soldered to corresponding ground pads on the circuit board 102. The terminating end 142 of the center contact 112 is configured to be terminated to the circuit board 102. A solder ball may be provided at the terminating end 142. Alternatively, the terminating end 142 may be configured to directly engage a corresponding signal pad on the circuit board 102, such as using a deflectable beam, a compliant pin, or an interference connection.

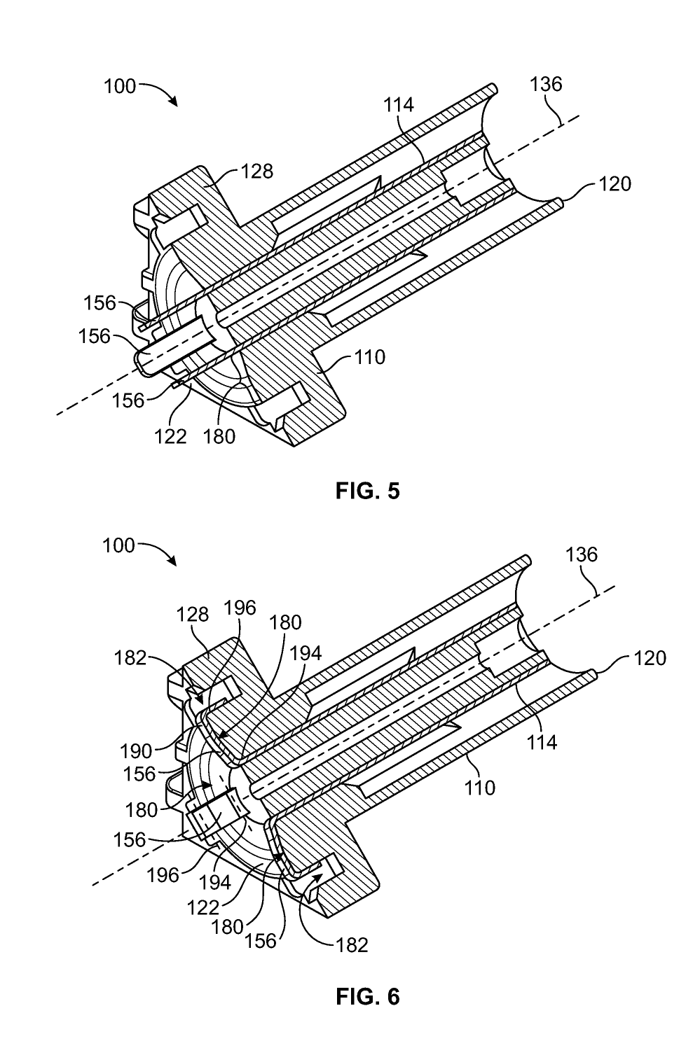

FIG. 5 is a rear perspective, partial sectional view of the coaxial connector assembly 100 showing the mounting legs 156 prior to bending the mounting legs 156 on the anvils 180. When the outer contact 114 is initially loaded into housing 110, the mounting legs 156 generally extend along the longitudinal axis 136. In an exemplary embodiment, the outer contact 114 is loaded into the housing 110 through the mating end 120. The mounting legs 156 are loaded through corresponding openings 192 through the base 128 such that portions of the mounting legs 156 extend beyond the mounting end 122. In an exemplary embodiment, the mounting legs 156 peripheral surround the terminating end 142 (shown in FIG. 2) of the center contact 112 (shown in FIG. 2) in a spaced apart configuration. The mounting legs 156 may be spaced equal distances from each other. The spacing from the center contact 112 may be selected to control the impedance of the coaxial connector assembly 100.

The anvils 180 are provided at the escape points of the mounting legs 156 from the openings 192. When the coaxial connector assembly 100 is to be surface mounted to the circuit board 102 (shown in FIG. 1), the mounting legs 156 are wrapped around the anvils 180 such that distal ends of the mounting legs 156 are received in the recesses 182. The anvils 180 may provide multiple different bend lines for the mounting legs 156 to shape the mounting legs 156 for surface mounting.

FIG. 6 is a rear perspective, partial sectional view of the coaxial connector assembly 100 showing the mounting legs 156 in a surface mount configuration. The mounting legs 156 have been bent around the anvils 180 such that distal ends of the mounting legs 156 are received in corresponding recesses 182. Back angles on the walls defining the recesses 182 cause the mounting legs 156 to hook around the base 128 into the recesses 182. The back angles prevents spring back or releasing of the distal ends of the mounting legs 156 to ensure that the mounting legs 156 remain in position along the anvils 180 for surface mounting to the circuit board 102.

With additional reference to FIG. 5, when the outer contact 114 is initially loaded into the housing 110, the mounting legs 156 extend axially along the longitudinal axis 136. The mounting legs 156 are bent against the anvils 180 to extend generally radially outward along the mounting end 122 of the housing 110. The mounting legs 156 are bent at a first bend line 194 (shown in FIG. 6), which is located generally at the escape point of the mounting legs 156 from the base 128. At the first bend line 194, the mounting legs 156 extend generally perpendicular with respect to the longitudinal axis 136 and the portion of the outer contact 114 within the housing 110. At the recesses 182, the mounting legs 156 are bent at a second bend line 196 by bending the distal ends of the mounting legs 156 into the recesses 182. Once bent, the distal ends of the mounting legs 156 extend generally parallel to the longitudinal axis 136 in a forward direction generally toward the mating end 120 of the housing 110 and away from the circuit board 102. The rearward most portions of the mounting legs 156 define the mounting interfaces 190 that are configured to be surface mounted to the circuit board 102.

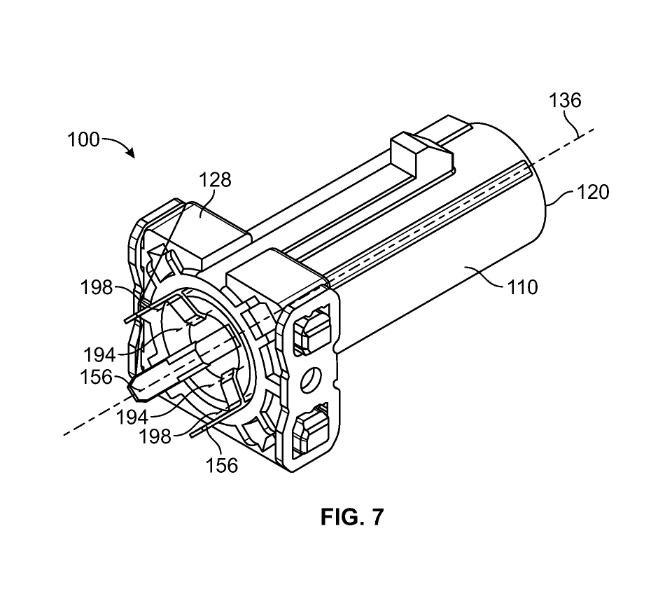

FIG. 7 is a rear perspective view of the coaxial connector assembly 100 showing the mounting legs 156 in a through-hole configuration. In the through-hole configuration, the mounting legs 156 are configured to be through-hole mounted to the circuit board 102. For example, the distal ends of the mounting legs 156 may be received in plated vias of the circuit board 102. During forming, the mounting legs 156 are bent at the first bend line 194 similar to the surface mount configuration. The mounting legs 156 are bent at a second bend line 198 such that the distal ends of the mounting legs 156 extend away from the base 128 of the housing 110, such as in an rearward direction. The distal ends of the mounting legs 156 extend generally parallel to the longitudinal axis 136. The distal ends of the mounting legs 156 extend away from the housing 110 such that the mounting legs 156 can be loaded into corresponding vias of the circuit board 102. The same outer contact 114 (shown in FIG. 2) is used for the through-hole configuration as the surface mount configuration. The mounting legs 156 are just bent in different ways at different bend lines to allow for surface mounting versus through-hole mounting. Forming the mounting legs 156 of the outer contact 114 is done in-situ after the outer contact 114 is loaded into the housing 110.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

What is claimed is:

1. A coaxial connector assembly comprising:
a housing having a mating end and a mounting end, the mounting end having anvils, the housing having a cavity;
a center contact received in the cavity, the center contact having a mating end and a terminating end; and
an outer contact received in the cavity, the outer contact having a mating cylinder surrounding the center contact, the outer contact having mounting legs extending from the mating cylinder, the mounting legs extending through the housing to the mounting end of the housing, the mounting legs being formed against the anvils for termination to a circuit board.

2. The coaxial connector assembly of claim 1, wherein the mounting legs are formed against the anvils for surface mounting to the circuit board, the anvils aligning the mounting legs in a co-planar manner.

3. The coaxial connector assembly of claim 1, wherein the mounting legs are formed against the anvils for through-hole mounting to the circuit board.

4. The coaxial connector assembly of claim 1, wherein the outer contact extends along a longitudinal axis, the outer contact being initially loaded into the housing such that the mounting legs extend axially along the longitudinal axis, the mounting legs being bent against the anvils to extend generally radially outward along the mounting end of the housing.

5. The coaxial connector assembly of claim 4, wherein the mounting legs are bent at a first bend line to extend generally radially outward along the mounting end of the housing, the mounting legs being further bent at a second bend line such that distal ends of the mounting legs extend generally parallel to the longitudinal axis.

6. The coaxial connector assembly of claim 1, wherein the mounting legs peripheral surround the terminating end of the center contact in a spaced apart configuration, the mounting legs being spaced equal distances from each other.

7. The coaxial connector assembly of claim 1, wherein the housing includes an outer contact support in the cavity, the outer contact being loaded into the cavity through the mating end of the housing such that the mating cylinder peripherally surrounds, and is supported by, the outer contact support and such that the mounting legs extend through the housing to the mounting end of the housing for termination to a circuit board.

8. The coaxial connector assembly of claim 1, wherein the outer contact includes a stamped and formed body defining the mating cylinder and the mounting legs, the mating cylinder having a seam extending longitudinally.

9. The coaxial connector assembly of claim 1, wherein the mating cylinder surrounds the center contact, the housing comprising an outer contact support formed integral with the housing and positioned between the center contact and the outer contact.

10. The coaxial connector assembly of claim 1, wherein the center contact and outer contact define an SMB interface and the mating end of the housing is keyed according to a desired FAKRA specification.

11. A coaxial connector assembly comprising:
a housing having a mating end and a mounting end, the housing having a base at the mounting end, the housing having a shell at the mating end defining a cavity configured to receive a mating connector assembly, the housing having an outer contact support extending from the base into the cavity, wherein the base, shell and outer contact support are formed integral with one another;
a center contact received in the cavity inside the outer contact support, the center contact having a mating end and a terminating end; and
an outer contact received in the cavity, the outer contact comprising a mating cylinder and mounting logs extending from the mating cylinder, the mounting legs extending from the mounting end of the housing for termination to a circuit board, the mating cylinder peripherally surrounding the outer contact support.

12. The coaxial connector assembly of claim 11, wherein the mounting end of the housing includes anvils, the mounting legs being formed against the anvils for terminating to the circuit board.

13. The coaxial connector assembly of claim 11, wherein the outer contact extends along a longitudinal axis, the outer contact being initially loaded into the housing such that the mounting legs extend axially along the longitudinal axis, the mounting legs being bent at a first bend line against anvils on the mounting end of the housing to extend generally radially outward along the mounting end of the housing, the mounting legs being further bent at a second bend line such that distal ends of the mounting legs extend generally parallel to the longitudinal axis.

14. The coaxial connector assembly of claim 11, wherein the outer contact is loaded into the cavity through the mating end of the housing such that the mating cylinder is supported by the outer contact support.

15. The coaxial connector assembly of claim 11, wherein the outer contact includes a stamped and formed body defining the mating cylinder and the mounting legs, the mating cylinder having a seam extending longitudinally.

16. The coaxial connector assembly of claim 11, wherein the mating cylinder surrounds the center contact with the outer contact support positioned between the center contact and the outer contact.

17. A coaxial connector assembly comprising:
a housing having a mating end and a mounting end, the housing having a cavity at the mating end configured to receive a mating connector assembly, the housing having an outer contact support extending into the cavity;
a center contact received in the cavity inside the outer contact support, the center contact having a mating end and a terminating end; and
an outer contact received in the cavity, the outer contact comprising a stamped and formed body defining a mating cylinder and mounting legs extending from the mating cylinder, the mounting legs extending from the mounting end of the housing for termination to a circuit board, the mating cylinder peripherally surrounding the outer contact support.

18. The coaxial connector assembly of claim 17, wherein the mounting end of the housing includes anvils, the mounting legs being formed against the anvils for terminating to the circuit board.

19. The coaxial connector assembly of claim 17, wherein the outer contact extends along a longitudinal axis, the outer contact being initially loaded into the housing such that the mounting legs extend axially along the longitudinal axis, the mounting legs being bent at a first bend line against anvils on the mounting end of the housing to extend generally radially outward along the mounting end of the housing, the mounting legs being further bent at a second bend line such that distal ends of the mounting legs extend generally parallel to the longitudinal axis.

20. The coaxial connector assembly of claim 17, wherein the mating cylinder surrounds the center contact with the outer contact support positioned between the center contact and the outer contact.
